(19) United States
(12) Patent Application Publication
(10) Pub. No.: US 2010/0132627 A1
(43) Pub. Date: Jun. 3, 2010

(54) Water Pet Support

(76) Inventor: Frank Vito Brandonisio, Glendale Heights, IL (US)

Correspondence Address: The Thompson Law Office, P.C., 831 S. State Street, Lockport, IL, 60441, US

(21) Appl. No.: 12/325,004

(22) Filed: Nov. 28, 2008

(51) Int. Cl. A01K 15/02

(52) U.S. Cl. 119/702

(57) ABSTRACT

A system for supporting a pet in a body of water is disclosed. The system may include a platform, one or more mounting devices, and one or more couplings. The system may be associated with a mooring for securing the mounting devices. The one or more couplings may each be secured to the one or more mounting devices and to the proximate portion of the platform. The couplings may be configured to permit the platform to move in relation to the one or more mounting devices such that the distal portion of the platform may rise when a net upward vertical force is applied to the lower surface of the platform when the animal is not on the platform, and the couplings may be configured to partially support the platform and the animal when the animal is on the platform, such that the platform may remain generally horizontal.

### BACKGROUND

1. Field

This invention is generally related to a system for supporting a pet in a body of water, such as a swimming pool, and more particularly, to a system for conveniently supporting a pet without compromising safety for humans and pets, while allowing access to, and egress from, the water.

2. Background

Many pet owners enjoy swimming with their pets. In particular, dog owners often enjoy swimming with their pets. Many owners also allow their pets to swim on their own. On beaches and other gradually sloping surfaces, this may be accomplished easily. However, most swimming pools have vertical sides that may present challenges to entering and exiting the pools. Similarly, when swimming from a pier, or from boat, or other craft, away from shore, accessing the pier, boat or other craft may require a structure, such as a ladder, to assist humans. Such ladders are generally not suitable for pets.

Various structures have been employed to allow, animals to exit water. For example: a boat boarding system for dogs is described in U.S. Pat. No. 5,829,380, to Smith; a pet pool safety system is described in U.S. Pat. No. 6,598,562, to Dutkiewicz, et al.; and a pet ramp was described in U.S. Pat. No. 7,011,045 to Zehner; all of which are incorporated herein by reference.

However, the previous systems fail to provide a convenient system for supporting a pet in a body of water, without compromising safety for humans and pets, while allowing access to, and egress from, the water.

### SUMMARY

Disclosed herein is a new and improved system for supporting a pet in a body of water without compromising safety for humans and pets, while allowing access to, and egress from, the water. In accordance with an aspect of the system, the system may include a platform, one or more mounting devices, and one or more couplings. The system may be associated with a mooring for the mounting device being, at least partially, disposed in the water. The platform may be configured to support the animal, and may have an upper surface and a lower surface. The platform may have a proximate portion and a distal portion. The proximate portion may be closer to the mooring than the distal portion when the platform is in a horizontal position.

The one or more mounting devices may be configured to be secured to the mooring. The one or more couplings may each be secured to the one or more mounting devices and to the proximate portion of the platform. The couplings may be configured to permit the platform to move in relation to the one or more mounting devices such that the distal portion of the platform may rise when a net upward vertical force is applied to the lower surface of the platform when the animal is not on the platform, and the couplings may be configured to partially support the platform and the animal when the animal is on the platform, such that the platform may remain generally horizontal.

Other systems, methods, aspects, features, embodiments and advantages of the water pet support disclosed herein will be, or will become, apparent to one having ordinary skill in the art upon examination of the following drawings and detailed description. It is intended that all such additional systems, methods, aspects, features, embodiments and advantages be included within this description, and be within the scope of the accompanying claims.

### BRIEF DESCRIPTION OF THE DRAWINGS

It is to be understood that the drawings are solely for purpose of illustration. Furthermore, the components in the figures are not necessarily to scale, emphasis instead being placed upon illustrating the principles of the system disclosed herein. In the figures, like reference numerals designate corresponding parts throughout the different views.

FIG. 1 is a side view of the pet support system employed with ladder supports, in which the pet support system includes an animal platform attached to the ladder supports by a mounting device and a coupling.

FIG. 2 is a front view of the pet support system employed with ladder supports of FIG. 1.

FIG. 3A is top view of the coupling of FIG. 1 and FIG. 2.

FIG. 3B is a front view of the coupling for FIG. 3A.

FIG. 4A is a top view of the mounting device of FIG. 1 and FIG. 2.

FIG. 4B is a front view of the mounting device of FIG. 4A.

FIG. 4C is a side view of the mounting device of FIG. 4A.

FIG. 5A is a back view of the animal platform of FIG. 1 and FIG. 2 including a coupling seat.

FIG. 5B is an enlarged view of the coupling seat of FIG. 5A.

FIG. 5C is a side view of the coupling seat of FIG. 5B.

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

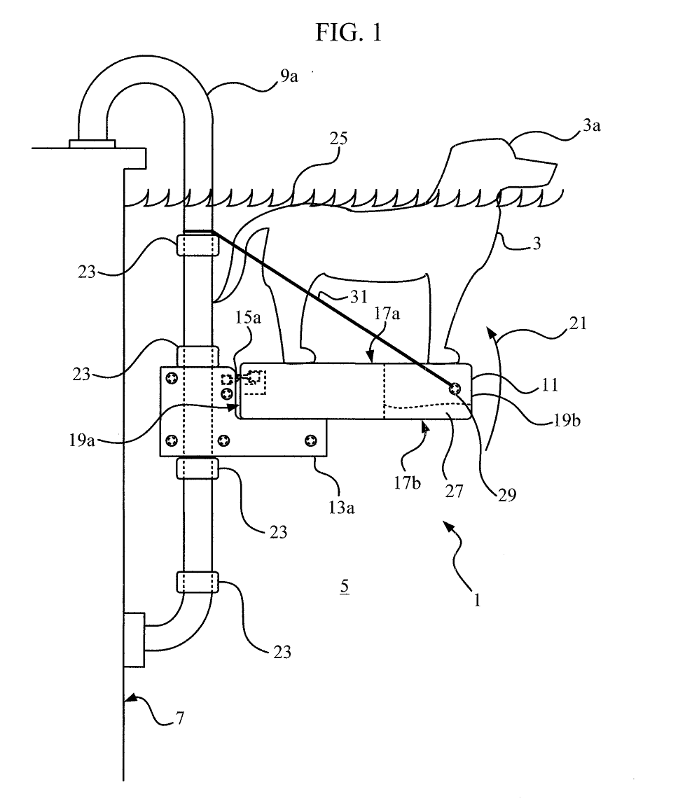

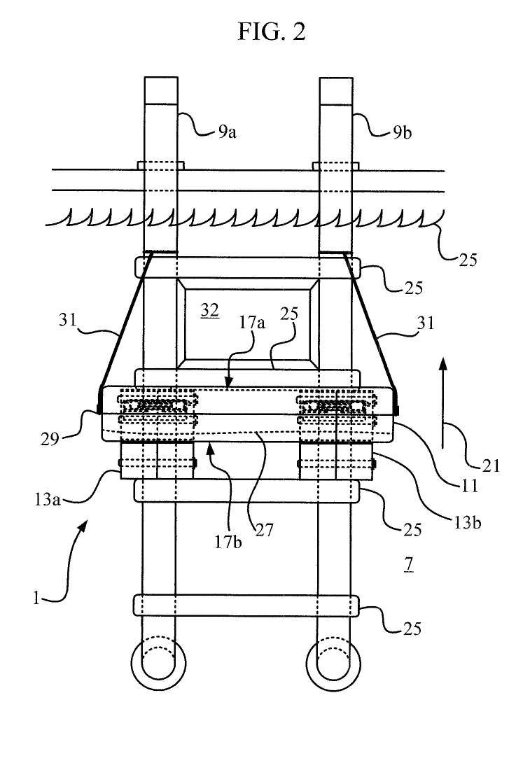

FIG. 1 and FIG. 2 show an exemplary pet support system 1 for supporting one or more animals 3 in water, such as, but not limited to a pool 5. Pool 5 may have one or more sides 7. One of more supports 9a and 9b (see FIG. 2) may be located proximate to pool side 7. Supports 9a and 9b may be, for example but not limited to, the side rails of a ladder, such as side rails associated with the ladders shown and described in U.S. Pat. No. 3,964,572 to Gannon, U.S. Pat. No. 7,017,045 to Laynmance, and U.S. Pat. No. 6,598,562, to Dutkiewicz, et al., which are entirely incorporated herein by reference.

A platform 11 may be attached to one or more mounting devices 13a and 13b (see FIG. 2), via one or more couplings 15a and 15b (see FIG. 2). Platform 11 may be configured to support the animal 3, such as a clog, by being constructed, in conjunction with the mounting devices 13a and 13b and couplings 15a and 15b, to be of sufficient size to accommodate the animal 3, and sufficient strength to support the animal 3. Platform 11 may have an upper surface 17a and a lower surface 17b. Platform 11 may have a proximate portion 19a and a distal portion 19b. Proximate portion 19a may be closer to pool side 7 when platform 11 is in a horizontal position, as illustrated in FIG. 1.

Couplings 15a and 15b may each be removably secured to the proximate portion 19a of platform 11. Couplings 15a and 15b may also each be removably secured to mounting devices 13a and 13b. Mounting devices 13a and 13b, couplings 15a and 15b, and platform 11 may be configured to permit platform 11 to pivot, as illustrated by arrow 21 such that distal portion 19b of platform 11 may rise when a net upward vertical force is applied to lower surface 17b of platform 11. Mounting devices 13a and 13b and couplings 15a and 15b may also be configured to support platform 11 such that platform 11 may remain generally horizontal, as illustrated in FIG. 1, when a net upward force is not applied to lower surface 17b of platform 11.

Steps 23 may be secured between supports 9a and 9b. One or more of the steps 23 may be used to assist in supporting mounting devices 13a and 13b upon supports 9a and 9b. For convenience, pet support system 1 is illustrated and described with preexisting pool ladders components, such as the supports 9a and 9b together with steps 23. However, pet support system 1 may also be supported in any manner, known to those having ordinary skill in the art, in which the mounting devices 13a and 13b may be secured in order allow the platform 11 to sit horizontally when no net upward force is applied to lower surface 17b, while allowing the head 3a of animal 3, to remain above the water surface 25. As non-limiting examples, pet support system 1 may be secured to vertical supports extending from a boat or pier (not shown), pet support system I may be secured to ladder supports without the steps 23 illustrated in FIG. 1 and FIG. 2, pet support system 1 may be secured directly to the pool side 7, and pet support system 1 may be secured to a common pool ladder for an above ground pool.

Platform 11 may be filled with sand 27, or any weighted matter, in order to maintain the buoyancy of platform 11, so that platform 11 may remain approximately horizontal when no upward form is applied to lower surface 17b. Platform 11 may also include one or more eyelets 29 for securing a rope 31 to provide further support for the distal portion 19b of platform 11. In addition to an eyelet, any other manner of securing rope 31 to platform 11 may be employed, as known to those having ordinary skill in the art. Similarly, rope 31 may be any type of material known to those having ordinary skill in the art that is suitable for supporting the distal portion 19b of platform 11, such as, but not limited to a wire, cable, and rubber. Pet support system 1 may also include a protective material 32 placed above and platform 11 so as to protect pool side 7, or any pool liner (not shown), from being damaged by animal 3.

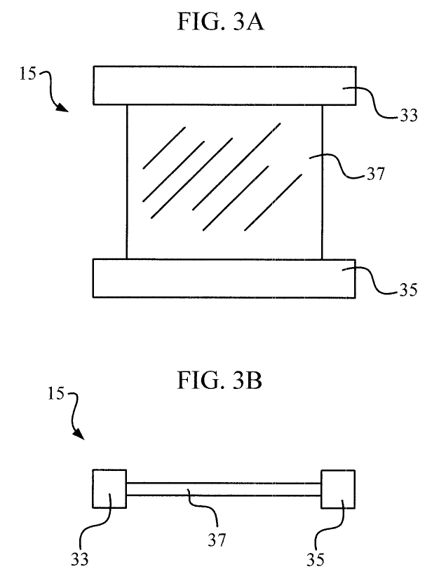

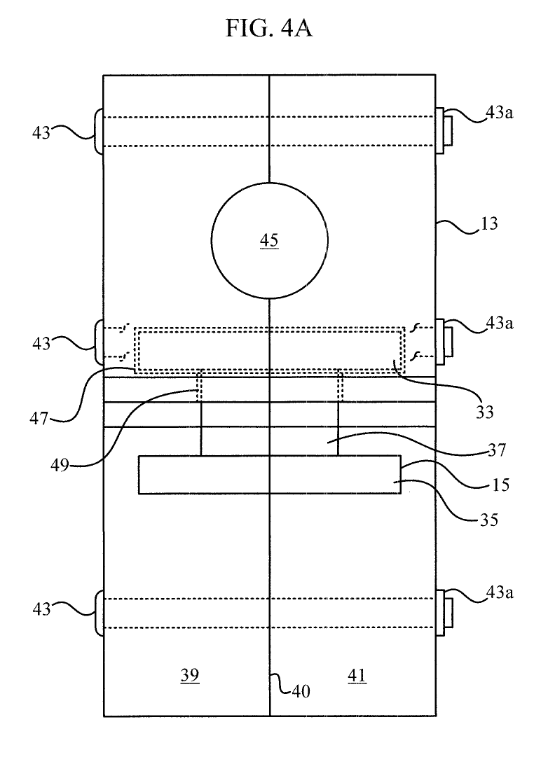

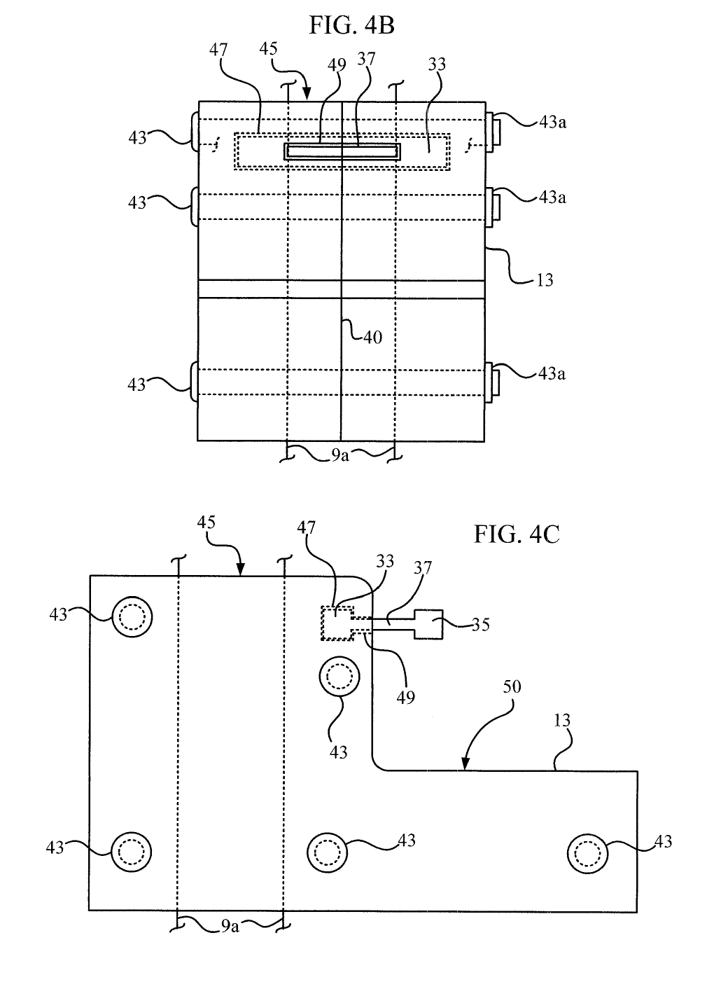

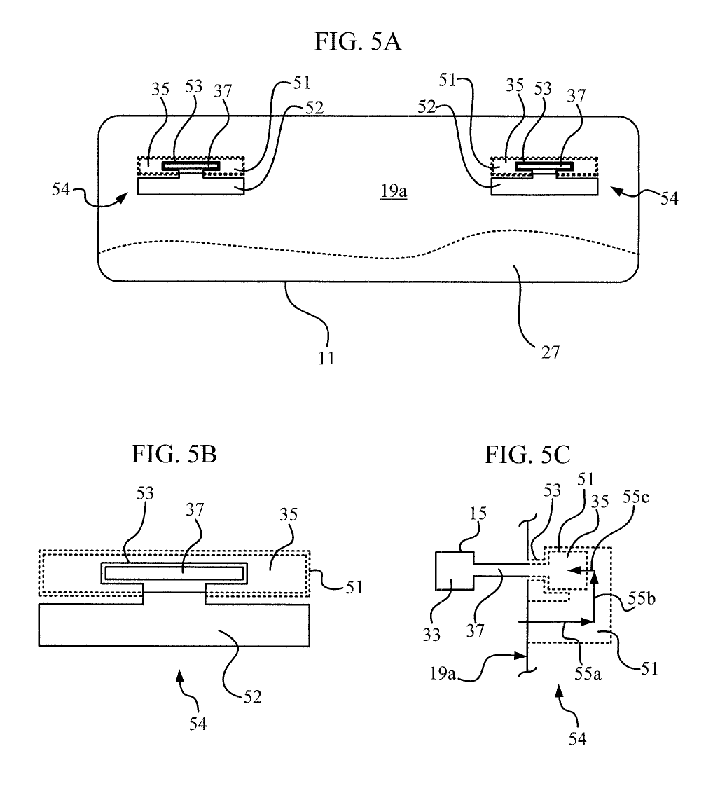

FIG. 3A and FIG. 3B show a top view, and a side view, respectively, of one of the one or more couplings 15a and 15b of FIG. 1 and FIG. 2, referred to in FIG. 3A through FIG. 5C as coupling 15. Coupling 15 may include a first anchor 33, a second anchor 35, and a coupling material 37 between first anchor 33 and second anchor 35. Although shown as rectangular blocks, first anchor 33 and second anchor 35 may be constructed in any geometry that is coordinated with first anchor void 47 (see FIG. 4A) and second anchor void 51 (see FIG. 5C) to permit first anchor 33 and second anchor 35 to be removably secured within first anchor void 4.7 and second anchor void 51. Coupling material 37 may be any material, known to those having ordinary skill in the art to be of sufficient strength to maintain its structural integrity when employed in the pet support system 1, while having sufficient flexibility to allow the movement of platform 11 in the direction of arrow 21 when a net upward force is applied to lower surface 17b.

FIG. 4A, FIG. 4B, and FIG. 4C show, a top view, a front view, and a side view, respectively, of the one or more mounting devices 13a and 13b of FIG. 1 and FIG. 2, referred to in FIG. 4A through FIG. 4C as mounting device 13. In FIG. 4A, FIG. 4B, and FIG. 4C, coupling 15 is also shown in cooperation with mounting device 13.

Mounting device 13 may include a first coupling portion 39 and a second coupling portion 41 that may be secured together using a plurality of fasteners 43. Fasteners may be bolts having nuts 43a, or any other type of fastener appropriate for joining the first and second coupling portions, as is known to those having ordinary skill in the art. First coupling portion 39 and second coupling portion 41 may be joined at divider 40 such that a support void 45 is formed. Support void 45 may be configured to allow supports 9a or 9b to pass through void 45 as illustrated in FIG. 1 and FIG. 2.

First coupling portion 39 and second coupling portion 41 may be joined at divider 40 such that a first anchor void 47 and a first coupling material void 49 are formed. First anchor void 47 may be configured to secure first anchor 33 of coupling 15. First coupling material void 49 may be configured to allow coupling material 37 to pass out of mounting device 13 as is best illustrated in FIG. 4C.

Upper surface 50 of mounting device 13 may be horizontal, as illustrated herein, or may have a slope to accommodate a slope, if any, of supports 9a and 9b, in order that platform 11 may be supported in a horizontal position. Alternatively, lower surface 17b of platform 11 may be angled to accommodate a slope, if any, of the supports 9a and 9b, in order that platform 11 may be supported in a horizontal position.

FIG. 5A shows proximate portion 19a of platform 11, including two coupling seats 54. FIG. 5B is an enlarged view of coupling seat 54. FIG. 5C is an enlarged side view of coupling seat 54. Coupling seat 54 may include one or more second anchor voids 51 that may be configured to removably secure second anchor 35 of couplings 15a and 15b. Second anchor voids may include a passageway 52 that may be formed in platform 11 such that second anchor 35 may be inserted into platform 11, as is illustrated by arrow 55a. Second anchor 35 may then be moved in relationship to platform 11 in the direction illustrated by arrow 55b. And then, second anchor 35 may be moved in relationship to platform 11 in the direction illustrated by arrow 55c in order to seat in second anchor 35 in second anchor void 51 such that second anchor may remain secured in second anchor void 51 when the platform is joined to mounting devices 13a and 13b by couplings 15a and 15b, as is illustrated in FIG. 1 and FIG. 2.

As is best illustrated in FIG. 5C, a second coupling material void 53 may be formed in platform 11 to allow coupling material 7 to pass out of platform 11, when second anchor 35 is seated in second anchor void 51.

An exemplary pet support system 1 for supporting animal 3 in a body of water, may be used with a mooring, such as the one or more supports 9a and 9b, that are partially disposed in the water. The exemplary pet support system 1 may include a platform 11, one or more mounting devices 13a and 13b, and one or more couplings 15a and 15b. Platform 11 may be configured to support animal 3, for example by being sized to support animal 3 and by having sufficient strength to support animal 3. The platform may include upper surface 17a and lower surface 17b. Platform 11 may have a proximate portion 19a and a distal portion 19b. Proximate portion 19a may be closer to the mooring, for example ladder supports 9a and 9b, than distal portion 19b when platform 11 is in a horizontal position. The one or more mounting devices 13a and 13b may be configured to be secured to the mooring, for example, by using fasteners to allow first coupling portion 39 and second coupling portion 41 to enclose a portion of the mooring.

The one or more couplings 15a and 15b may each be secured to the one or more mounting devices 19a and 19b and to the proximate portion 19a of platform 11. Couplings may also be secured to at least one of the one or more mounting devices 13a and 13b and configured to permit platform 11 to move in relation to the one or more mounting devices 13a and 13b such that distal portion 19b of platform 11 may rise when a net upward vertical force is applied to lower surface 17b of platform 11 when animal 3 is not on platform 11. Couplings 15a and 15b may be configured to partially support platform 11 and animal 3 when animal 3 is on platform 11, such that platform 11 may remain generally horizontal.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make and use the invention, and not necessarily to limit the scope of legal protection afforded the appended claims.

The above description of the disclosed embodiments is provided to enable any person skilled in the art to make or use that which is defined by the appended claims. The following claims are not intended to be limited to the disclosed embodiments. Other embodiments and modifications will readily occur to those of ordinary skill in the art in view of these teachings. Therefore, the following claims are intended to cover all such embodiments and modifications when viewed in conjunction with the above specification and accompanying drawings.

What is claimed is:

1. A system for supporting an animal in a body of water, a mooring being, at least partially, disposed in the water, the system comprising:
a platform configured to support the animal, the platform having an upper surface and a lower surface, the platform having a proximate portion and a distal portion, the proximate portion being closer to the mooring than the distal portion when the platform is in a horizontal position;
one or more mounting devices configured to be secured to the mooring; and
one or more couplings, each coupling secured to one of the one or more mounting devices and to the proximate portion of the platform, the couplings configured to permit the platform to move in relation to the one or more mounting devices such that the distal portion of the platform may rise when a net upward vertical force is applied to the lower surface of the platform when the animal is not on the platform, and the couplings are configured to at least partially support the platform and the animal when the animal is on the platform, such that the platform may remain generally horizontal.

2. The system of claim 1, wherein the mooring is one Dr more portions of a pool ladder.

3. The system of claim 1, wherein the one or more couplings includes a first anchor and a second anchor, wherein the first anchor is secured to one of the one or more mounting devices, and the second anchor is secured to the platform.

4. The system of claim 3, wherein the one or more mounting devices include a void for securing the first anchor to the mounting device.

5. The system of claim 3, wherein the platform includes a void and a passageway for removably securing the second anchor to the platform.

6. The system of claim 1, wherein the one or more mounting devices include a first portion and a second portion, wherein the first and second portions may be secured together using fasteners in order to leave a void to allow the mounting device to be secured to the mooring.

7. The system of claim 1, wherein the one or more mounting devices includes an upper surface configured to contact the lower surface of the platform, wherein the upper surface of the mounting device is configured to at least partially support the platform and the animal.

8. The system of claim 1, further comprising:
a means for supporting the distal portion of the platform.
